(19) United States
(12) Patent Application Publication
(10) Pub. No.: US 2009/0112365 A1
(43) Pub. Date: Apr. 30, 2009

(54) APPARATUS AND METHOD FOR POLYMERISATION SURGICAL CEMENT

(76) Inventors: John F Orr, Co Down (GB); Nicholas Dunne, Belfast (GB)

Correspondence Address: ALIX YALE & RISTAS LLP, 750 MAIN STREET, SUITE 1400, HARTFORD, CT, 06103, US

(21) Appl. No.: 11/909,859

(22) PCT Filed: Mar. 28, 2006
(86) PCT No.: PCT/GB06/01122

§ 371 Date: Oct. 27, 2008

(30) Foreign Application Priority Data
Mar. 29, 2005 (GB) 0506186.6

(51) Int. Cl. G05B 23/00

(52) U.S. Cl. 700/269

(57) ABSTRACT

An apparatus for monitoring the polymerisation of surgical cement comprising a container for holding the surgical cement, sensing means to detect at least one environmental factor affecting surgical cement polymerisation or property of surgical cement indicating the level of polymerisation, wherein the sensing means is adapted to produce an output according to at least one environmental factor or property. The apparatus further comprises signal means to inform a user of the condition of the surgical cement according to the output of the sensing means. Suitably at least one environmental factor or property of the surgical cement is ambient temperature, ambient humidity, temperature of the surgical cement, viscosity of the surgical cement or the speed of sound through the surgical cement.

The present invention relates to apparatus and methods for monitoring the polymerisation of surgical cement, especially bone cement. It relates particularly, but not exclusively, to apparatus and methods for monitoring surgical cement polymerisation during and/or after mixing.

UK primary knee replacements will increase from 32,942 in 2000 to 53,712 in 2010. Furthermore, UK hip replacements are predicted to rise from 38,425 in 2000 to 46,772 in 2010. A further 10,000 hip and 6,000 knee revisions will be conducted each year. whilst it is difficult to identify the direct cause of revision failure, according to the Swedish National Hip Arthroplasty Registry 2000, 76% of revisions are caused by aseptic loosening (loosening without incidence of infection). Additional studies have shown that the majority of aseptic loosening is due to cement mantle failure.

Revision hip and knee operations represent a huge cost to the Health Service in the UK, draining financial and professional resources that could otherwise be used to carry out primary procedures. The costs can be broken down into direct and human costs.

Direct costs associated with poor cement mixing include; revision operations, pre-operative preparation, post-operative care in hospital and the community, use of valuable bed space, strain on blood resources and extended waiting lists.

The human costs related to inadequate cement mixing include; stress from additional operations, increased mortality, increased bone removal and additional discomfort.

A cemented implant inevitably is as good as it will ever be on the day it is implanted. However, it is important to maximise the lifespan of the implant. Accordingly, the surgeon must choose the optimum implant, make the correct bone cuts, choose the best cement and ensure the cement is applied correctly.

Bone cement, which is typically an acrylic material, is essentially a grout material that sits between the bone and implant; bone cement is the link allowing the transfer of load through the new joint.

To enable bone cement to do this job properly, certain standards must be achieved:
Good micro-interlock where the cement and the bone meet.
Good interface between the cement and implant.
Cement must be mechanically sound and able to withstand the magnitude of the loads transferred across the joint.

The aim of a good cement mix is to produce bone cement with the best mechanical properties to carry out its load transfer role successfully over the lifetime of the implant.

The most common types of bone cement are polymethyl methacrylate cements (PMMA), and the basis of virtually all of these is a powdered polymer and liquid monomer, which are mixed together in an approximate ratio of 2:1 to form cement. To initiate the formation of the solid bone cement, two initiators are included in the cement mix.
Benzoyl peroxide in the powder
N,N-dimethyl-p-toluidine in the liquid

When mixed together, these cause the benzoyl peroxide to release free radicals that initiate a controlled polymerisation (curing) reaction. The polymerisation reaction is an exothermic reaction with a peak temperature ranging 80-120° C. frequently being reported.

Table 1 shows four stages, periods or phases of polymerisation for acrylic bone cement.

TABLE 1

| | |
|---|---|
| Mixing | Full integration of the powder and liquid |
| | components |
| Waiting | At the end of which the cement can be |
| | handled without sticking to the surgical |
| | gloves |
| Working | The time during which the cement can be |
| | manipulated and the prosthesis inserted |
| Setting | At the end of which the cement is fully |
| | hardened |

It is important that the user, typically a surgeon and his assistants, are aware of when each of these stages begins and ends. Typically in the operating theatre it is a matter of estimation to determine the time required for the various stages. For example, a surgeon will typically feel for the correct consistency or temperature of the cement to determine the end of the waiting and working periods respectively. This is clearly an unsatisfactory method which results in highly inconsistent cement quality.

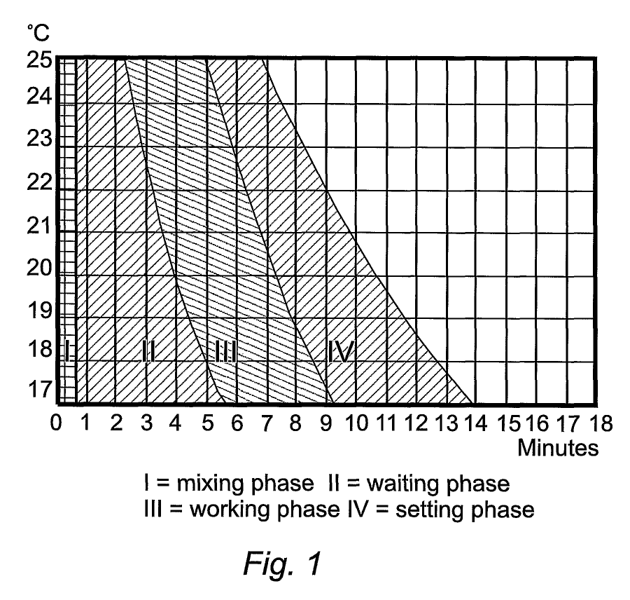

For all bone cements, all the phases of cement polymerisation get shorter as the temperature increases. If the temperature of an operating room is not controlled, which is often the case, then the reduction in the cement working time on a hot day may be a consistent problem. It is also likely that the humidity of an operating room will also influence the polymerisation reaction of the acrylic bone cement. The storage temperature and hence the initial temperature of the powder and liquid constituents also has an effect on the temperature when mixing. The effect of ambient temperature on the polymerisation phases for a typical acrylic bone cement is shown in the accompanying FIG. 1.

The ultimate aim of good mixing technique is where the powder and liquid components of the cement mix are fully combined and the final mix has low porosity, increasing its strength and resistance to creep and fatigue failure. The method of mixing is an important factor influencing cement quality. It has been shown that fatigue fractures are most likely to occur where there are the largest voids and that the porosity of the cement has a major influence on its mechanical performance. There is also a significant correlation between mechanical properties of bone cement and unmixed powder content.

All current cement mixing methods can be categorised into three generations depending on the mixing technique used:

First Generation—Bowl and Spatula
Manual
Mixes under atmospheric conditions
Operator dependent
High levels of porosity
Poor mechanical performance of the bone cement
Open monomer vapour exposure

Second Generation—Modified Mixing Bowl
Manual
Low vacuum (−30 kPa)
Moderate mechanical performance
Reduced monomer vapour exposure
Reduced porosity

Third Generation—Sealed, Combined Mixing and Delivery System
Manual
High vacuum (−69 to −92 kPa)
Minimal monomer vapour exposure
Low level of porosity
Improved mix quality
Reduced human contact

Studies of the mixing protocols for bone cement in operating theatres at Musgrave Park Hospital (MPH), Belfast, Northern Ireland from 1996-2004 have revealed that the theatre mixed cements exhibit porosities of up to 19% compared to the best laboratory mixing results of 2-4%. It can be concluded that significant improvements in cement quality can be achieved by adopting a more controlled and repeatable mixing procedure.

The problems associated with bone cement are equally associated with other cement-like materials which are mixed and then polymerise (cure), and where temperature and other environmental factors can affect the rate of polymerisation (curing). For example materials used in dental restorations have similar properties to bone cement, and suffer from the same problems in the clinical environment.

Accordingly the term surgical cement is used to encompass bone cement, dental cements and other materials which have similar properties to bone cement, and where control of mixing and monitoring of polymerisation may be of benefit.

There is a need for improved methods and apparatus to enhance surgical cement quality.

According to the present invention there is provided an apparatus for monitoring the polymerisation of surgical cement comprising;
a container for holding the surgical cement,
sensing means to detect at least one environmental factor affecting surgical cement polymerisation or property of surgical cement indicating the level of polymerisation, wherein the sensing means is adapted to produce an output according to at least one environmental factor or property, and signal means to indicate a condition of the surgical cement according to the output of the sensing means.

In a preferred embodiment the surgical cement is bone cement or dental cement.

Suitably at least one environmental factor or property of the surgical cement is ambient temperature, ambient humidity, temperature of the surgical cement, viscosity of the surgical cement or the speed of sound through the surgical cement.

In an embodiment of the present invention the apparatus is adapted to receive a sample of pre-mixed surgical cement, suitably bone cement. Suitably the apparatus may be adapted to be used in conjunction with a surgical cement mixer where a sample of recently mixed cement can be put into the container immediately after mixing, or following the waiting period. It is useful to monitor a sample of the mixed surgical cement so that the working time can be determined and the user can be informed when the surgical cement is no longer suitable for use. Additionally, it is useful to retain a sample of the surgical cement which may be kept in a patient's files to provide a record of the characteristics of the surgical cement used; this could prove useful in clinical governance, hospital auditing and in future patient support.

In another embodiment of the present invention the apparatus is a surgical cement mixer, suitably a bone cement mixer having a chamber, wherein the chamber is the container of the apparatus. Optionally the apparatus may comprise more than one container, one being the mixing chamber of a surgical cement mixer, another being a container to receive a sample of mixed surgical cement.

It is generally preferred that the surgical cement mixer has some vibrating function i.e. it is adapted to mix the cement by vibrating, agitating or otherwise moving the mixing chamber optionally also with an attached impeller or blade. Mechanically controlled mixers are known in the art, for example in EP0506317A2, U.S. Pat. No. 4,787,751, U.S. Pat. No. 4,531,839. The use of impellers or blades is known, for example in EP0178658A2, WO95/01832A1, WO 99/06140A1.

Suitably the mixing chamber of the mixer is disposable. Where the chamber is disposable it can conveniently be provided pre-filled with the powder component of the surgical cement.

Conveniently the mixing chamber is provided with attachment means for attaching a nozzle for application of the surgical cement. The attachment means may be an adaptor having a screw thread for screwing on a nozzle having a threaded portion. The adaptor is provided with sealing means to prevent cement exiting the chamber or air from entering the chamber until the nozzle is attached. The sealing means may suitably be a membrane which is punctured by the nozzle as it is attached. Alternatively it may be a valve which is normally held in the closed position, but is forced into the open position when the nozzle is attached.

Suitable nozzles are known in the art. A preferred nozzle which is not known in the art may be tapered to a narrowing where the cement exits the nozzle.

The nozzle may also have a weakened portion to allow a piece of nozzle to be broken off containing a sample of the bone cement to be retained.

The mixing chamber may conveniently be shaped and sized so as to fit into a device for forcing the surgical cement out of the chamber for administration to a patient. Such devices are well known in the art and include skeleton guns and the like. Accordingly the chamber may be adapted to be deformable or have a piston which is movable within the chamber to allow the cement to be forced from the chamber.

It is preferred that the mixer has means to induce a vacuum in the container during the mixing procedure. The vacuum may suitably be greater than 30 kPa below atmospheric pressure, preferably greater than 69 kPa below atmospheric pressure, or more preferably greater than 72 kPa below atmospheric pressure. Suitably the vacuum is created by a vacuum pump attached to the container. Mixing under a vacuum reduces the porosity of the surgical cement by extraction of air and other gases.

The vacuum can also conveniently be used to draw the liquid part of the cement into the mixing chamber. This has the advantage that it removes the need for manual introduction of the liquid which could introduce air into the cement.

Preferably the mixer has means to remove noxious fumes released as a result of the polymerisation reaction. Suitably the noxious fumes may be removed by use of a chemical or charcoal filter, which can be adapted to filter the gases drawn to the vacuum pump.

Monitoring environmental factors and properties of the surgical cement allows adjustments to the amount of time involved in the mixing, waiting and working periods to be made. At a higher ambient temperature, for example, these times will all be reduced.

In one embodiment the sensing means comprises a temperature sensor to detect the ambient temperature surrounding the surgical cement. Ambient temperature has a significant effect on the rate of surgical cement polymerisation.

In an alternative embodiment the sensing means comprises a temperature sensor to detect the temperature of the surgical cement. Because surgical cement polymerises by means of an exothermic reaction, temperature changes can be used to monitor the different stages of curing of the bone cement. Suitably the signal means is adapted to provide a signal when the temperature of the surgical cement rises above a set value. In this embodiment the temperature sensor is suitably provided in or on a wall of the container, and may either be in contact with the cement, or separated from the cement by the wall of the container or other suitable heat conducting layer. The temperature of surgical cement increases as it cures, generally increasing until polymerisation is complete. Once the cement reaches a temperature associated with the beginning or end of a particular period of the polymerisation process, this can be used as an indicator of the end of the particular period. In particular, temperature of the cement may suitably be used to indicate the end of the working period, and thus inform the user that any remaining cement should be discarded. For example, a temperature of around 59 to 64° C. is typically indicative of the cement reaching a stage of 90% curing, though of course this may vary between different bone cements.

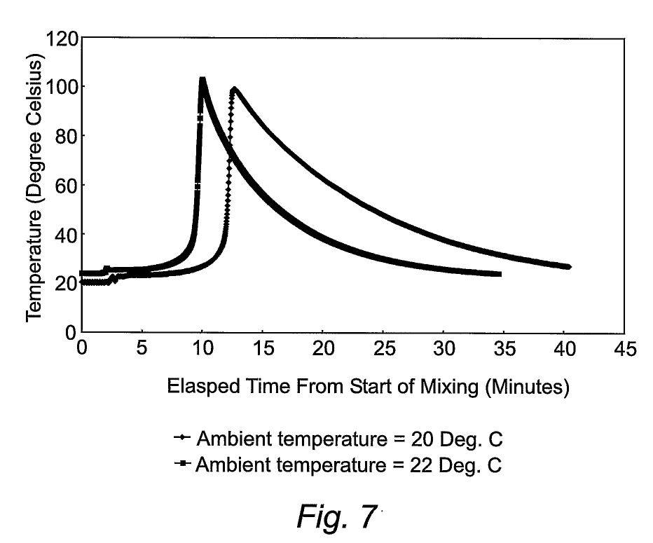

Table 2 shows typical temperatures associated with the polymerisation of a commercial bone cement at ambient temperatures of 20 and 22° C. These figures can be derived from the graph of the accompanying FIG. 7.

TABLE 2
Temperature data measured for commercial acrylic
bone cement in accordance with BS ISO 5833: 2002,
Implants for surgery - Acrylic resin cements.

| | Mix 1 (20° C.) | Mix 2 (22° C.) |
|---|---|---|
| Maximum Temp (° C.) | 99.16 | 102.97 |
| Cure Temp (° C.) | 59.78 | 63.71 |
| Cure Time (mins) | 9.63 | 12.21 |

The cure temperature and cure time represent the point at which the cement has attained 90% of its solidification.

A suitable temperature sensor can be a thermocouple able to cover the range of temperatures relevant to bone cement polymerisation (generally 40 to 140° C.).

In a further embodiment the sensing means comprises a humidity sensor to detect the ambient humidity level surrounding the surgical cement. The level of humidity can affect the rate of curing of surgical cement.

In yet a further embodiment the sensing means comprises ultrasonic sensing means to detect the viscosity of the surgical cement or the speed of sound transmission in the cement. As surgical cement polymerises its viscosity increases. Because the speed and attenuation of sound are sensitive to the viscoelastic properties of a polymer, ultrasound can be used to monitor the curing process of the bone cement thus indicating a point in the polymerisation process. In one embodiment the signal means is adapted to provide a signal when the viscosity of the cement rises above a set value thus indicating a point in the polymerisation process. When the viscosity reaches a certain level, this can be used as an indication of the end of the working or other period. Alternatively the ultrasonic sensing means can provide regular or real time information of the properties of the cement. Suitably the ultrasonic sensing means detects time of flight and/or amplitude of a pulse of ultrasound passing through portion of the cement.

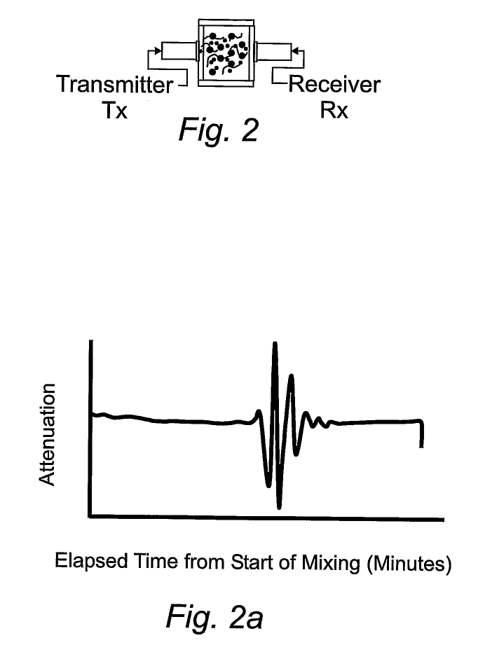

Suitable ultrasonic sensing means are well known in the art (Krauskramer Inc., USA or Panametrics Inc., USA). Typical ultrasonic sensing means comprise two transducers that are oriented facing each other on different sides of a sample. The transducers are connected to an ultrasonic digitising oscilloscope (Hewlett Packard, USA or National Instrument Laboratories, USA) and the signal obtained can suitably be transferred via a GPIB or a USB connection to a personal computer. Suitable transducers are available from Krauskramer Inc., USA or Panametrics Inc., USA. Changes in the time of flight and amplitude of the signal over time can be used to calculate changes in viscosity of the sample. FIG. 2 shows a schematic representation of an ultrasonic sensing means.

In a preferred embodiment the apparatus comprises more than one sensing means. Use of more than one sensing means may provide a more complete picture of the polymerisation process.

Preferably the apparatus comprises an adjustable timing means which is adjustable according to the output of the sensing means. Where more than one sensing means is present, the timing means can be adjusted according to the output of one or more of the sensing means. The adjustable timing means generally cooperates with the signal means, and suitably both the timing means and the signal means may be integrated in a single unit, e.g. a computer. Alternatively the output of the signal means could be manually input into the adjustable timing means, i.e. with a keypad. This is more suitable for imputing data which does not change rapidly such as ambient temperature or humidity.

Suitably the timing means is preset with at least one time point representing a stage in the polymerisation of the surgical cement at a standard temperature and humidity. This time point is adjusted depending on the output from the sensing means. Suitably the time point represents a suitable time for the end of the mixing period, end of the waiting period or end of the working period. Preferably the timing means is preset with more than one time point.

The adjustable timing means may also conveniently control the mixing process in a surgical cement mixer. The cement mixer would typically have a computer incorporating the adjustable timing means, which also controls the operation of the mixer. The timing means is programmed with the mixing time for the particular type of surgical cement to be mixed. This time is generally provided by surgical cement manufacturers for a standard temperature (e.g. 20° C.). However, mixing time varies according to the factors discussed above and thus the sensing means can be used to adjust the mixing time according to the ambient temperature or humidity; in an operating theatre the temperature is typically significantly above usual room temperature because of the large number of people and machines present in theatre. Once the time point indicating the end of the mixing period has been reached, the machine is stopped.

The signal means serves to provide a signal to inform the user of the status of the surgical cement or to alert the user to a change in the status. It may achieve this in any way that can be sensed by the user; suitably using a visual and/or audible signal. It is envisaged that in a simple embodiment the signal may be a visual stimulus such as a coloured light and/or an audible alarm. Alternatively the signal may be a display which depicts a graphical representation the polymerisation process and which shows at which point in this process the cement is currently at. Preferably the graphical representation is a line graph of time versus viscosity, temperature or other indicator representative of the polymerisation process, with one or more of the mixing, waiting, working and setting periods marked. A moving line or band moves across the graph, along the time axis, and a visual and/or audible signal indicates to the user that the next time period has been reached. This form of display is particularly suitable as users are familiar with such a representation of the polymerisation process.

According to a further aspect of the present invention, there is provided a method of monitoring the polymerisation of surgical cement, said method comprising:
a) placing at least a portion of the surgical cement in a container comprising sensing means to detect at least one environmental factor affecting surgical cement polymerisation or property of the surgical cement indicating the level of polymerisation;
b) detecting the at least one environmental factor or property of the surgical cement; and
c) providing a signal informing a user of the condition of the surgical cement using a signalling means.

Suitably the surgical cement is bone cement. Suitably the environmental factor or property of the surgical cement is ambient temperature, ambient humidity, temperature of the surgical cement, viscosity of the surgical cement or the speed of sound through the surgical cement. Suitable sensing means are as described above.

The method may further comprise the step of providing adjustable timing means which is adjustable depending on the at least one environmental factor or property of the surgical cement.

According to a further aspect of the present invention, there is provided a method of mixing surgical cement, said method comprising the steps of:
a) providing surgical cement to be mixed in a container;
b) detecting at least one environmental factor affecting surgical cement polymerisation or property of the surgical cement indicating the level of polymerisation of the surgical cement;
c) mixing the surgical cement for a period of time adapted according to the at least one factor or property.

Suitably the surgical cement is bone cement.

Suitably the environmental factor or property of the surgical cement is ambient temperature, ambient humidity, temperature of the surgical cement, viscosity of the surgical cement or the speed of sound through the surgical cement. Suitable sensing means are as described above.

Suitably step c) comprises providing the mixing time for the surgical cement at standard conditions and adjusting the mixing time dependent on the environmental factor or property of the surgical cement. The mixing may suitably be achieved by oscillating the container.

Preferably the surgical cement is mixed in a vacuum.

Suitably step a) may comprise providing the powder component of the bone cement in a container and adding the liquid component thereto or vice versa i.e. providing the liquid component of the bone cement in a container and adding the powder component thereto. Conveniently the powder component of the surgical cement is pre-packaged in the container and the liquid component is drawn into the container under the influence of a vacuum.

Suitably the method further comprises the step of monitoring the polymerisation of the surgical cement. This may conveniently be achieved by putting a sample of cement in a second container comprising sensing means, or at least a sample of the cement may by retained in the cement mixer.

According to a further embodiment of the present invention, there is provided a method of mixing surgical cement comprising the step of retaining at least a portion of the mixed surgical cement. Retention of a portion of the surgical cement may be useful in ongoing patient monitoring, hospital auditing, clinical governance or for other post-operational analysis. The sample may be retained in any suitable container, preferably a suitably shaped mould. Optionally the container may also serve to monitor the polymerisation of the cement. Alternatively the sample of cement may be retained in a portion of a nozzle used to administer the cement to a patient.

The methods of the present invention hereinbefore described can use the apparatus of the present invention as hereinbefore described.

Embodiments of the present invention will now be described, by way of example only, with reference to the accompanying drawings in which:

FIG. 1 shows the effect of different ambient temperatures on the polymerisation phases of acrylic bone cement

FIG. 2 shows a schematic representation of an ultrasonic sensing means to measure the viscosity of bone cement;

FIG. 2a is a typical plot of attenuation versus elapsed time from the start of mixing;

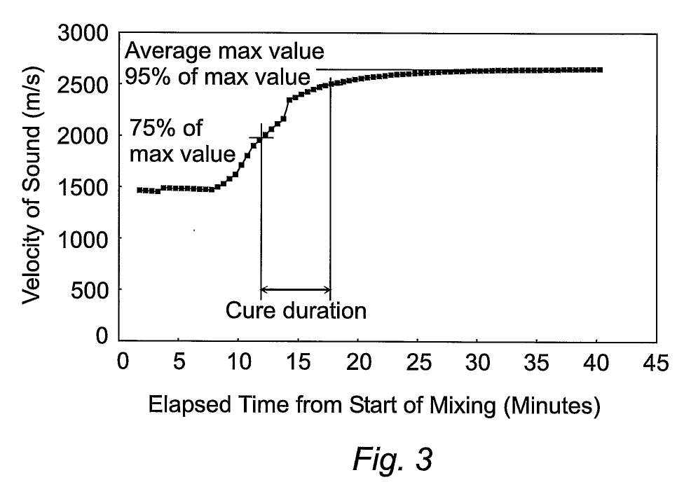

FIG. 3 shows the velocity of sound for acrylic bone cement plotted against elapsed time from the start of mixing;

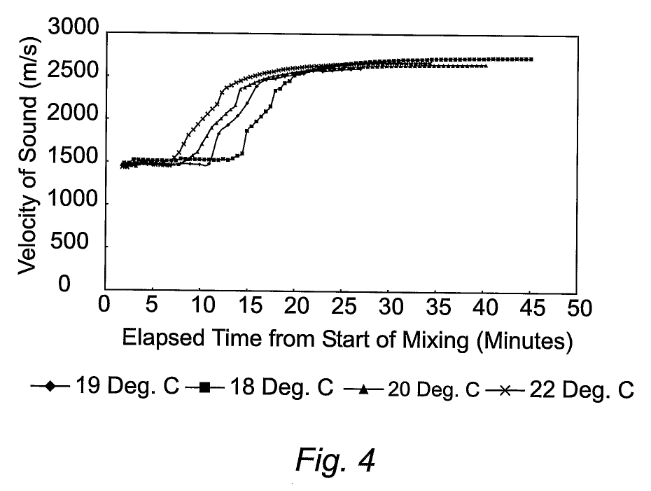

FIG. 4 compares the effect of different ambient temperatures on velocity of sound for acrylic bone cement plotted versus elapsed time from the start of mixing;

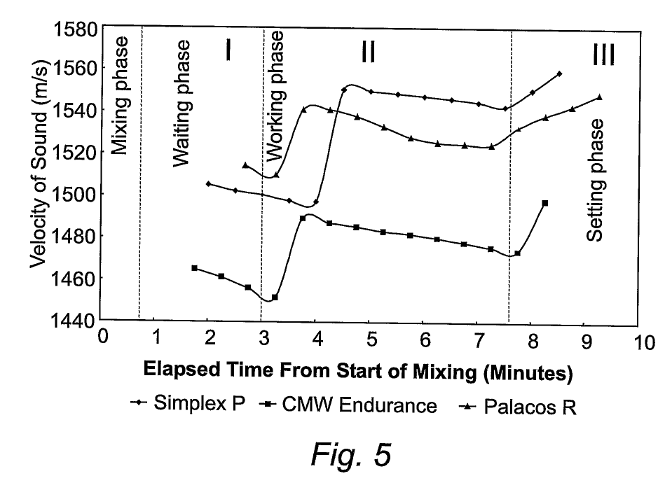

FIG. 5 shows the velocity of sound versus elapsed time from the start of mixing for three proprietary brands of acrylic bone cement during the working phase;

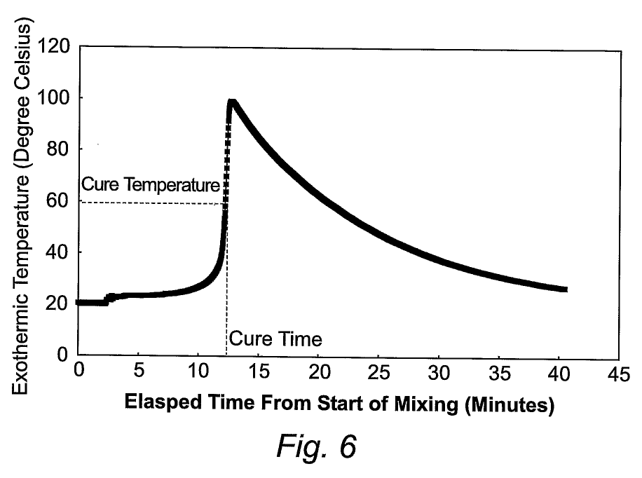

FIG. 6 shows the temperature of acrylic bone cement versus elapsed time from the start of mixing;

FIG. 7 shows the temperature of acrylic bone cement versus elapsed time from the start of mixing comparing changes in ambient temperature;

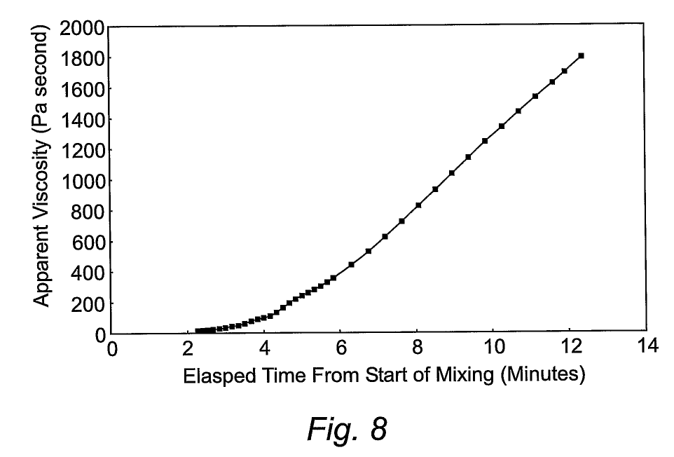

FIG. 8 shows the apparent viscosity of commercial bone cement versus elapsed time during the polymerisation process;

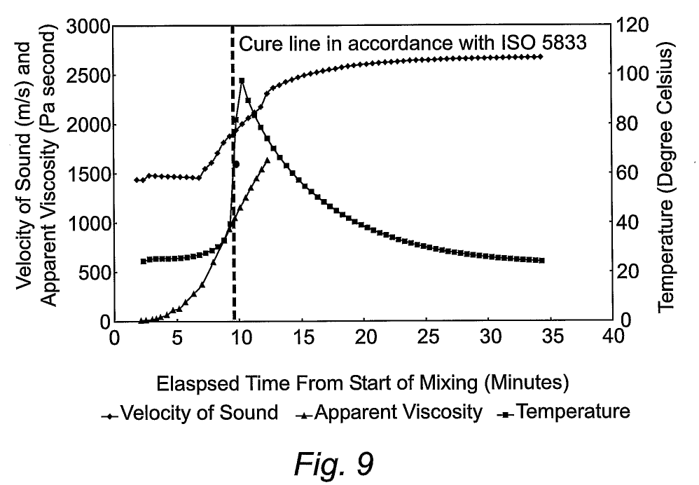

FIG. 9 shows a comparison of the velocity of sound, curing bone cement temperature and apparent viscosity of bone cement versus elapsed time;

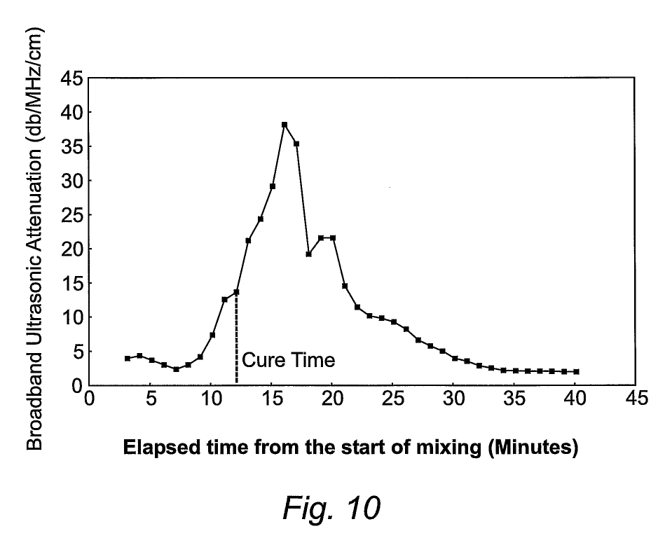

FIG. 10 shows Broadband Ultrasonic Attenuation (BUA) for a sample of acrylic bone cement versus elapsed time from the start of mixing;

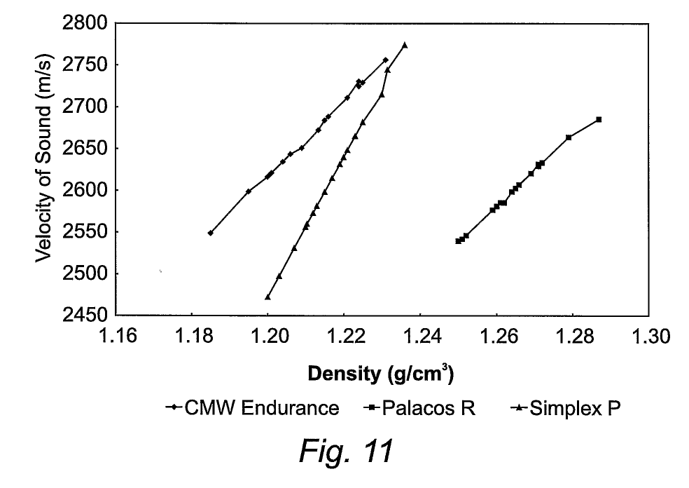

FIG. 11 shows velocity of sound through fully cured bone cement versus density for three proprietary brands of acrylic bone cement; and

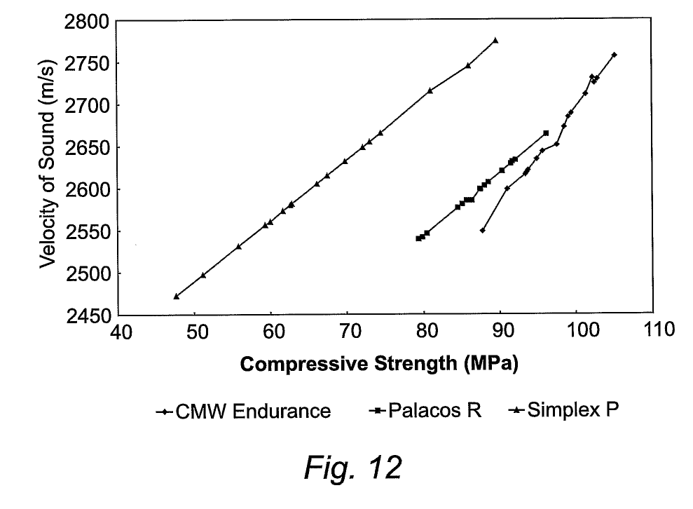

FIG. 12 shows the velocity of sound through fully cured bone cement versus compressive strength for three proprietary brands of acrylic bone cement.

### EXAMPLE 1

In this example, mixing is performed under a vacuum, most suitably around 72 kPa below atmospheric pressure, though lower or higher pressures could be used. Application of a vacuum during the mixing process reduces the level of porosity of the mixed bone cement by reducing the potential for air to be mixed into the bone cement, and hence improves its mechanical properties. The vacuum is applied using a vacuum pump. Pumps suitable for use in the present invention include oil-free diaphragm pumps such as those supplied by KNF Neuberger UK Ltd, UK, which draw a maximum of 95 kPa in vacuum mode, used in parallel with solenoid valves such as those sold by Connexion Developments Ltd., UK and vacuum transducers, made by Pressure-Vacuum-Level Ltd UK that provide a sensing mechanism to control and maintain the desired vacuum level. The solenoid valves are chosen to operate in a range of 0 to 100 kPa in vacuum mode of operation.

A charcoal or chemical filter is used to remove fumes created by the polymerisation process. Mains supply and/or rechargeable batteries (e.g. nickel-cadmium) can be used to power the bone cement mixer. Suitably a battery is used as a backup to a mains supply in case the mains supply to the mixer fails, thus avoiding the loss of a batch of cement. The components that come into direct contact with the bone cement are disposable and may be conveniently supplied as a cement mixing kit. This kit can comprise a mixing chamber (container) which is suitably a barrel which is provided pre-filled with the powder component of the cement. The chamber is clamped into position on the mixing chamber housing. Other disposable components of the cement mixing kit may include cement nozzles, which are used to inject the cement in a controlled manner once mixed. The disposable components are conveniently supplied in a kit pack that is pre-sterilised.

The mixing machine comprises an adjustable timing means which controls the mixing process. The adjustable timing means is conveniently incorporated in a computer. Suitable adjustable timing means are well-known in the art and appropriate devices can be obtained from, for example NEC, USA or Texas Instruments, USA. The adjustable timing means is set with the mixing and polymerisation characteristics of the particular bone cement being mixed. This data is typically provided by bone cement suppliers. The timing means is suitably set by introducing the necessary data via the keypad of the computer which incorporates the adjustable timing means. Keypads suitable for use in the present invention include membrane keypads that have a moulded, engineering grade of silicone rubber, such as supplied by RS Components, UK or Farnell Ltd., UK. Silicone based polymer sealing of the keypad protects it from fluids and dust.

The adjustable timing means can also be programmed with the storage condition of the cement prior to mixing, e.g. stored at room temperature or chilled at 4° C.

It is envisaged that the data may conveniently be provided for different types of cement in an encoded or predetermined form, suitably as a string of numbers; such a string of numbers could be provided on a swipe card which would be a highly convenient way of introducing the necessary data, or could be entered via a keypad.

Furthermore, additional information may by input into or recorded on the computer which may be useful in auditing procedures within the hospital, e.g. type of bone cement, type of joint replacement, size of mix and viscosity of bone cement. Conveniently the computer is connected to a printing device, such as a label printer, which provides a hard copy of a record of all relevant information regarding a particular bone cement mix. Information such as date, theatre operating conditions, mixing time, vacuum level applied during mixing, etc. may also be recorded. Suitable label printing components can be purchased from RS Components UK or Farnell, UK.

Sensing means are provided to detect ambient temperature, ambient humidity, and the viscosity and temperature of the bone cement, and produce an output accordingly. Suitable temperature and humidity sensors are well known in the art, such as those sold by Pico Technology Ltd., UK. Viscosity sensors which are based on ultrasonic technology are also well known in the art and typical features of such sensors were described earlier.

The output of the sensing means is then fed into the computer incorporating the adjustable timing means, and adjustments to the timing means are made accordingly. Suitably the output from the sensing means is transferred by wireless technology to the computer, such wireless hardware is available from National Instruments. A programmable software system interprets the output of the sensing means. Software suitable for use in the interface and analysis software is well known, such as LabVIEW that is supplied by National Instruments, USA.

Bone cement manufacturers typically provide information about the effects of ambient temperature and ambient humidity on curing of bone cement, and this data can be used to make the necessary adjustments to the timing means. If data is not available for a particular type of cement, it would require some routine experimentation to determine the effects of various factors upon the polymerisation process.

The manner in which the output from the various sensing means is used to adjust the timing means depends on the type of cement being used. Typically higher ambient temperatures result in accelerated polymerisation, and thus shorter mixing, waiting and working periods. FIG. 1 shows four phases: I=Mixing phase, II=working phase, III=application phase, IV=Setting Phase. For each type of cement the level of adjustment required for a given temperature would require some experimentation to determine, although usually this data will be provided by manufacturers. In a similar manner, the effect of humidity and significance of the temperature, and/or viscosity of the bone cement may be assessed experimentally, or may be provided by the cement manufacturers.

Table 1 hereinbefore shows the four phases of polymerisation for acrylic bone cement. All the phases of cement polymerisation decrease as the ambient temperature increases. The effect of ambient temperature on the polymerisation phases for acrylic bone cement is shown in FIG. 1, which will influence that management, delivery and integrity of the bone cement. It is critical that the surgeon is fully aware of the rate of polymerisation of bone cement as a function of ambient temperature and account accordingly.

FIGS. 1 to 10 demonstrate the typical phases and changes that occur during the polymerisation of commercial acrylic bone cement.

FIG. 2 is a schematic representation of how the bone cement can be monitored using ultrasonic technology. There is a transmitter (Tx) for sending a pulse to the bone cement in a vessel and a receiver (Rx) for receiving a signal. The transmitter and receiver are located opposingly about the vessel for mixing bone cement. The consequential steps are;

a)pulse generation, b) transmitter sends pulse to cement, c) pulse passes through cement, d) signal received and amplified, d) signal is digitised, e) signal is processed, f)cure data is updated and displayed on a PC, e)data files stored on PC. An alternative is using pulse-echo technology. FIG. 2a is a trace that is obtained directly from the ultrasonics technology from FIG. 2 showing a typical plot of attenuation versus elapsed time from the start of mixing.

FIGS. 3 to 10 show that the polymerisation of bone cement can be monitored using parameters such as velocity of sound, temperature or apparent viscosity. The values of the viscosity of the cement directly reflect the stage in the polymerisation process as shown in FIGS. 8 and 9. The temperature of the bone cement also directly reflects the stage in the polymerisation process, again as shown in FIGS. 1, 7 and 9. Thus data from these sensors can be directly used as indicators of the stage in the polymerisation process and adjustment to the timing means can be made accordingly.

Using both environmental factors and properties of the cement to adjust the timing means allows real time adjustments to be made according to a number of indicators. This allows a highly accurate model of the polymerisation process to be generated and adjusted according to changes, either in ambient conditions or in the cement itself. It is possible, of course, to use fewer sensing means for example only one or more ambient conditions or one or more properties of the cement; this would result in a less accurate model of the polymerisation process to be generated, but would still provide a significant improvement over prior art techniques.

FIG. 3 shows the variation in velocity of sound over time since mixing as a function of polymerisation reaction through self-curing acrylic bone cement. Each data point corresponds to one digitised signal that has been analysed to calculate the velocity. As the bone cement polymerised, the velocity of sound through it increased significantly near the expected cure time. One of the advantages of the monitoring system is the accurate indication of the working phase for acrylic bone cement using a non-invasive and non-destructive ultrasonic technique, as the early stages of polymerisation are of most interest. The cure time is defined as the time when the velocity of sound reached 75% of the average maximum value obtained after hardening. The cure duration is defined as the time difference between 75% and 95% of the average maximum velocity of sound value.

FIG. 4 compares the effect of different ambient temperatures on velocity of sound for acrylic bone cement plotted versus elapsed time from the start of mixing. It can be noted from the results that an increase in ambient temperature directly correlates with an earlier increase in velocity of sound reflecting a faster cure duration period. FIG. 5 displays the variation in velocity of sound during the waiting phase (I), working phase(II) and setting phase (III)for three proprietary acrylic bone cements, Simplex (diamonds), CMW Endurance (squares) and Palacos R (triangles). Each bone cement type displayed a similar trend throughout this time period, whereby the velocity of sound decreased by approximately 10-20 m/s between three and four minutes depending on the cement type, this time point corresponded to the onset of the working phase of the bone cement. Thereafter, the velocity of sound through the respective bone cement sample increased by 30-50 m/s, followed by a gradual decrease in velocity of sound and a subsequent rise that reflected the transition to the setting phase of the polymerisation reaction. This shift to the setting phase occurred between seven and eight minutes depending on the bone cement type. These two distinctive points are consistent with the start and end of the working phase of PMMA bone cement. To assess the validity of using the cure time and cure duration, the polymerisation reaction for each bone cement was monitored in accordance with ISO 5833 and ASTM F451 concurrent with each ultrasonic test conducted.

FIG. 6 shows the exothermic temperature profile for acrylic bone cement versus elapsed time from the start of mixing. The cure temperature and cure time are parameters that were determined in accordance with ISO 5833 and ASTM F451. Cross-comparing the data generated from the ultrasonic technique and the ISO and ASTM standards it can be observed that there is a strong correlation between 75% of the average maximum velocity of sound value and the cure time as measured in accordance with ISO 5833 and ASTM F451 (Table 3)

Table 3 summarises the average values of the different parameters that were measured in this example.

TABLE 3

| | | | | | | Com- |
|---|---|---|---|---|---|---|
| | Cure | Cure | Final | Cure | | pressive |
| Bone | Time | Duration | Velocity | Time | Density | Strength |
| Cement | (Min.) | (Min.) | (m/s) | (Min.) | (g/cm³) | (MPa) |
| Endurance | 12.40 ± | 4.79 ± | 2654 ± | 12.18 ± | 1.21 ± | 98.00 ± |
| | 1.51 | 1.56 | 60 | 1.77 | 0.01 | 4.90 |
| Palacos R | 11.95 ± | 4.55 ± | 2586 ± | 11.70 ± | 1.27 ± | 87.46 ± |
| | 0.34 | 0.63 | 13 | 0.21 | 0.01 | 4.53 |
| Simplex P | 14.63 ± | 4.93 ± | 2655 ± | 14.61 ± | 1.22 ± | 66.21 ± |
| | 2.29 | 1.59 | 21 | 2.41 | 0.01 | 11.79 |

The data shown in Table 3 is obtained directly or determined from the ultrasonic test conducted. The different parameters measured using the ultrasonic test provide the surgeon with important information during a surgical procedure that will allow him/her to accurately manage the mixing and delivery of the bone cement, e.g. transition between the different phases of polymerisation, cure time. Additionally, the ultrasonic test will accurately provide post-mix characterisation of the bone cement in terms of physical and mechanical properties.

The average cure time measured for CMW® Endurance was 12.40±1.51 minutes when measured at 75% of the average maximum using the ultrasonic technique, in contrast to 12.18±1.77 minutes when quantified using the ISO and ASTM test methods. This confirms that the method and apparatus of the present invention can provide the accuracy of the ISO and ASTM test methods.

FIG. 7 shows the temperature of acrylic bone cement versus elapsed time from the start of mixing comparing changes in ambient temperature process (Dark line: 20° C., Light line: 22° C.). These results indicate that an increase in ambient temperature significantly increases the rate of polymerisation for acrylic bone cement from the start of mixing. The cure time for the bone cement prepared at 22° C. demonstrated a cure time of 9.63 minutes when quantified using the ISO and ASTM test methods. In contrast the bone cement mixed at an ambient temperature of 20° C. polymerised fully within 12.21 minutes. This information will be particularly critical to a surgeon when mixing bone cement so that he/she may accurately adjust/monitor the stages of polymerisation of the bone cement.

FIG. 8 shows the apparent viscosity of commercial bone cement versus elapsed time during the polymerisation process. Information regarding viscosity is very beneficial to the surgeon as it provides an indication of the cement's resistance to flow, which is a determinant for when is the appropriate time for bone cement introduction into the surgical cavity.

FIG. 9 shows a series plots comparing the velocity of sound (diamonds), curing bone cement temperature (squares) and apparent viscosity of bone cement (triangles) obtained simultaneously during the polymerisation of commercial acrylic bone cement. It can be observed from FIG. 9 that there is a correlation between temperature exhibited during curing of the bone cement and the velocity of sound recorded using full flight ultrasonic characterisation techniques.

FIG. 10 displays a typical graph for BUA versus elapsed time from start of mixing for a curing acrylic bone cement. Each data point represents one digitised signal that has been analysed to BUA. This plot shows data from the same sample as the velocity of sound data in FIG. 3. The maximum BUA coincides with the midpoint of transition in velocity of sound. For all samples, BUA had a sharp maximum against a slow increasing background. A shoulder on the high side of the maximum may imply a second peak at a lower magnitude. This shoulder was a consistent feature in all BUA data.

FIG. 11 demonstrates the correlations between velocities of sound through the bone cements as a function of densities of the cured samples (Simplex (Triangles), CMW Endurance (Diamonds) and Palacos R (Squares). It can be observed from the FIG. 11 that there is a significant relationship relating velocity of sound and density of the cement for all three bone cements investigated in this study (R2=0.99).

FIG. 12 shows the relationship between velocity of sound and compressive strength of the cured bone cement sample of three proprietary brands (Simplex (Triangles), CMW Endurance (Diamonds) and Palacos R (Squares). It can be noted from FIG. 12 that the relationship between velocity of sound through the cement and compressive strength is linear and highly significant (R2=0.99). In both the cases, as the velocity of sound increased the density and compressive strength increased proportionately. The adjustable timing means controls the mixing of the bone cement in the mixer by starting the mixer at the beginning of the mixing cycle, and stopping the machine when mixing is complete, i.e. the end of the time period allocated for mixing, as adjusted according to the environmental factors or properties of the cement.

A display (the signal means) provides a representation of the polymerisation process, i.e. all stages from the start of mixing to setting, which is derived from monitoring of the environmental factors affecting bone cement polymerisation or property of the bone cement indicating the level of polymerisation of the surgical cement. The display shows a graph of time versus progress of the polymerisation process. Suitably temperature or viscosity of the bone cement is used to represent progress through the polymerisation process, but equally an arbitrary representation (e.g. % polymerisation) could be derived and used. The mixing, waiting, working and setting periods are suitably marked out as bands of colour on the graph to provide a clear indication of progress through the polymerisation process. As time progresses a line moves along the graph showing how much time has expired, and thus showing user how much time is left in each period. An audible alarm also sounds when a particular time period expires.

Additionally, the display may show the speed of the actuator and other details of interest. For example the display may have indicators/light emitting diodes (LEDs), which highlight whether the mixer is being powered by mains supply or battery. If the actuator of the mixing machine is being driven by battery there can be a visible indication of the remaining battery life available. Additionally, there can be LEDs to demonstrate when the batteries of the mixing machine are being charged. LEDs suitable for use in this present invention are supplied by Maplin, UK.

In operation, a polymer powder and liquid monomer are mixed in the mixing chamber. The mixing chamber is supplied pre-filled with polymer powder. The mixing chamber is sealed and a vacuum is applied. The liquid component of the bone cement is introduced into the mixing chamber as a result of the application of the vacuum, without the requirement for human input. This allows the mixing and delivery system to be a complete closed system, therefore reducing the likelihood of air being entrapped in the bone cement during powder and liquid introduction into the mixing chamber.

The mixer is then started. The actuator of the mixer operates under the control of the timing means, which is adjusted according to the environmental factors affecting surgical cement polymerisation or property of the bone cement indicating the level of polymerisation of the bone cement.

At the end of the mixing stage, mixing stops and an alarm sounds to alert the operator. The alarm sounds 5 seconds before the cement is adequately mixed, thus forewarning the user that the cement is reaching a critical stage. After mixing is complete, the vacuum is released and the chamber can be removed from the mixing chamber housing. The mixing chamber is placed in a cement injection gun. The mixing barrel is secured in place by means of a screw thread or a bayonet fitting, such types of cement injection gun are well known in the art. Many different designs of injection gun are available.

A delivery nozzle is attached to the mixing chamber by means of a screw thread provided on the chamber. Long nozzles can be used, for example, to allow delivery of the cement to the intermedullary canal of the femur, while other nozzles are relatively short in length. The nozzle used to deliver the cement can be tapered, which is particularly advantageous for cement that is being injected into the femoral cavity. Currently, nozzles used for the injection of bone cement are parallel nozzles (Ø11-14 mm), which do not facilitate the injection of cement into femoral cavities that are small in diameter (i.e. <9 mm). Furthermore, using a tapered nozzle for injecting the cement will increase the shear rate of the cement and hence reduce its viscosity, therefore allowing for greater penetration of the cement into the porous cancellous bone matrix.

Once mixing is completed there is a waiting period before the cement becomes workable and enters the working period. The length of this period is again affected by ambient temperature and humidity and reflected by the temperature and viscosity of the bone cement, and the adjustable timing means is adjusted depending on the output of the sensing means.

Once the waiting period has expired the user is alerted by the display and an alarm, and can apply the bone cement to a patient. The display continues to indicate the progress of the polymerisation process so that the user is aware of how much working time is left. The user is informed once the working period has expired.

The bone cement is injected by the operator to the appropriate surgical site.

The delivery nozzle has a reduced radius or vee-notch in the lower third of the nozzle. This stress concentration achieved by the vee-notch or reduced radius provides a weakened area to allow a portion of the nozzle containing a specimen of bone cement to be broken off.

This specimen can form the basis of a control cement sample, which can be used for prospective auditing and quality procedures. The bone cement specimen can conveniently be labelled with a label printed from the printer mentioned earlier. The label contains sufficient information that allows for full traceability of the bone cement sample.

Optionally a sample of bone cement may be placed into a separate chamber for further monitoring as described below. This allows the physical properties of the bone cement to be monitored as it polymerises during the working period.

The bone cement mixer described has the advantages of being mechanical and automated, thus reducing to a minimum the need for attention by the theatre staff. Additionally, the feedback mechanism controls the mixing cycle and thus prevents over or under mixing.

### EXAMPLE 2

### Sample Retention Chamber for Monitoring the Polymerisation Process

A sample retention chamber may be provided for use in monitoring the polymerisation of a sample of mixed bone cement. The sample retention chamber also serves to retain a sample of the cement as a record of the cement used in a particular operation. It comprises a container to receive a sample of bone cement. The container comprises a top and bottom half. The bottom half is provided with a channel to receive a temperature sensor that will monitor the polymerisation of the cement. Other sensing means such as ultrasonic sensing means can be provided as required.

Such a chamber can be used in conjunction with existing bone cement mixers which do not detect any environmental factors or properties of the cement, to allow improved monitoring of the progression of bone cement polymerisation.

Alternatively it could be integrated with a mixing machine which has sensing means to allow continued monitoring of the polymerisation process during the working period.

The chamber can have sensing means for temperature and/or viscosity of the cement, ambient temperature and ambient humidity.

The output of the various sensing means is sent to a computer which comprises an adjustable timing means. The adjustable timing means is preset with the data for the particular cement being used. The adjustable timing means is adjusted according to the output of the sensing means in the same way as described above for in Example 1. If the chamber is to be used with the mixer of Example 1 then the computer is suitably the same computer, and the output of the sensing means would be used to continue adjustment of the timing means. Where the sample retention chamber is used with a mixer that does not have any adjustable timing means (e.g. a prior art mixer), separate adjustable timing means would be used. The timing means would obviously not have a time point for the mixing period, and the first time point would be for the beginning of the waiting or working periods. In this embodiment the sample retention chamber provides the user with information about the progression of the polymerisation progress, but does not provide information on the mixing process.

### EXAMPLE 3

### Sample Retention Chamber with Alert for End of Working Period

A simpler sample retention chamber may be useful to indicate to the user the end of the working period. Such a chamber would have sensing means to detect the viscosity and/or temperature of the bone cement.

Once the viscosity and/or temperature reach a certain threshold, signal means alert the user. Suitably the signal means produces an audible alarm.

The threshold is generally set at a level which coincides with the end of the working period. Alternatively, it may be set at a threshold which indicates the impending end of the waiting period, thus giving a warning to the surgeon that time is running out.

It may be particularly useful to have two signals which go off at different thresholds, one indicating that the end of the working period is coming up, the other to indicate the end of the working period.

The output from the temperature sensor is sent to a computer which incorporates signal means. When the temperature of the cement reaches a temperature preset into the computer, the signal is produced which indicates that the end of the working period has been reached. The temperature used as the threshold unit will depend on the type of cement being used.

It should be that other factors may affect the polymerisation or may provide an indication of the stage of polymerisation of bone cement, and sensing means to detect such other factors may be used in addition to, or instead of, the sensing means mentioned herein.

1. An apparatus for monitoring the polymerisation of surgical cement comprising;
a) a container for holding the surgical cement,
b) sensing means to detect at least one environmental factor affecting surgical cement polymerisation or property of surgical cement indicating the level of polymerisation, wherein the sensing means is adapted to produce an output according to at least one environmental factor or property;
c) signal means to indicate a condition of the surgical cement according to the output of the sensing means.

2. An apparatus as claimed in claim 1 in which the surgical cement is bone cement or dental cement.

3. An apparatus as claimed in claim 1 and claim 2 wherein the at least one environmental factor or property of the surgical cement is ambient temperature, ambient humidity, temperature of the surgical cement, viscosity of the surgical cement or the speed of sound through the surgical cement.

4. An apparatus as claimed in any one of the preceding claims adapted to receive a sample of premixed surgical cement, suitably bone cement.

5. An apparatus as claimed in any one of the preceding claims comprising a surgical cement mixer, suitably a bone cement mixer having a chamber, wherein the chamber is the container of the apparatus.

6. An apparatus as claimed in claim 5 comprising more than one container, one being said mixing chamber of a surgical cement mixer, another being a container to receive a sample of mixed surgical cement.

7. An apparatus as claimed in claim 5 or claim 6 wherein said surgical cement mixer is a vibrating mixer.

8. An apparatus as claimed in any one of the preceding claims wherein said container is disposable.

9. An apparatus as claimed in any one of the preceding claims wherein said container is provided with attachment means for attaching a nozzle for application of the surgical cement.

10. An apparatus as claimed in claim 9 wherein said attachment means is provided with sealing means to prevent cement exiting the chamber or air from entering the chamber until the nozzle is attached.

11. An apparatus as claimed in claim 9 or claim 10 comprising said nozzle having a weakened portion adapted to allow a piece of nozzle to be detached whilst containing a sample of the bone cement to be retained.

12. An apparatus as claimed in any one of claims 5 to 11 wherein said mixer includes a vacuum means to induce a vacuum in the container during the mixing procedure.

13. An apparatus as claimed in any one of the preceding claims wherein said mixer includes an extractor to remove noxious fumes.

14. An apparatus as claimed in any one of the preceding claims wherein said sensing means comprises a temperature sensor to detect the ambient temperature surrounding the surgical cement.

15. An apparatus as claimed in claim 14 wherein said temperature sensor also detects the temperature of the surgical cement.

16. An apparatus as claimed in claim 14 and claim 15 wherein said temperature sensor is in or on a wall of the container, and/or in contact with the cement.

17. An apparatus as claimed in any one of claims 14 to 16 in which said temperature sensor is a thermocouple.

18. An apparatus as claimed in any one of the preceding claims wherein the signal means is adapted to provide a signal when the temperature of the surgical cement rises above a predetermined value.

19. An apparatus as claimed in any one of the preceding claims in which said sensing means comprises a humidity sensor able to detect the ambient humidity level surrounding the surgical cement.

20. An apparatus as claimed in any one of the preceding claims wherein said sensing means comprises ultrasonic sensing means to detect the viscosity of the surgical cement or the speed of sound transmission in the surgical cement.

21. An apparatus as claimed in any one of the preceding claims wherein said signal means is adapted to provide a signal when the viscosity of the surgical cement rises above a predetermined value.

22. An apparatus as claimed in any one of the preceding claims wherein said sensing means can provide regular and/or real time information of the properties of the surgical cement.

23. An apparatus as claimed in any one of the preceding claims including more than one sensing means.

24. An apparatus as claimed in any one of the preceding claims including a timing means adjustable according to the output of said sensing means.

25. An apparatus as claimed in claim 24 wherein the output of the signal means is manually input into the adjustable timing means.

26. An apparatus as claimed in claim 24 wherein. said timing means is preset with at least one time point representing a stage in the polymerisation of the surgical cement at a predetermined temperature and humidity.

27. An apparatus as claimed in. Claim 26 wherein said timing means is preset with more than one time point.

28. An apparatus as claimed in any one of the preceding claims wherein the signal is a visual stimulus.

29. An apparatus as claimed in any one of the preceding claims wherein the signal is a display which depicts a progression of the cement polymerisation process.

30. A method of monitoring the polymerisation of surgical cement, said method comprising at least the steps of:
a) placing at least a portion of the surgical cement in a container comprising sensing means to detect at least one environmental factor affecting surgical cement polymerisation or property of the surgical cement indicating the level of polymerisation;
b) detecting at least one environmental factor or property of the surgical cement; and
c) providing a signal informing a user of the condition of the surgical cement.

31. A method of monitoring the polymerisation of surgical cement as claimed in claim 30, wherein the environmental factor or property of the surgical cement is one or more of the group comprising: ambient temperature, ambient humidity, temperature of the surgical cement, viscosity of the surgical cement or the speed of sound through the surgical cement

32. A method of monitoring the polymerisation of surgical cement as claimed in claim 30 and claim 31, said method further comprising the step of providing timing means as defined in claim 24, claim 26 and claim 27 adjustable depending on the at least one environmental factor or property of the surgical cement.

33. A method of monitoring the polymerization of surgical cement as claimed in any one of claims 30 to 32 using the apparatus as defined in any one of claims 1 to 29.

34. A method of mixing surgical cement, said method comprising at least the steps of:
a) providing surgical cement to be mixed in a container;
b) detecting at least one environmental factor affecting surgical cement polymerisation or property of the surgical cement indicating the level of polymerisation of the surgical cement; and
c) mixing the surgical cement for a period of time adapted according to at least one factor or property.

35. A method of mixing surgical cement as claimed. in claim 34, said method further comprising the step of providing pre-determined mixing time for the surgical cement at standard conditions and adjusting the mixing time dependant on the environmental factor or property of the surgical cement.

36. A method of mixing surgical cement as claimed in claim 34 and claim 35, said mixing method further achieved by vibrating the container as claimed in claim 1.

37. A method of mixing surgical cement as claimed in any one of claims 34 to 36, said method further comprising the step of retaining at least a portion of the mixed surgical cement.

38. A method of mixing surgical cement as claimed in any one of claims 34 to 37 using the apparatus as defined in any one of claims 1 to 29.
